(19) United States
(12) Patent Application Publication
(10) Pub. No.: US 2022/0342114 A1
(43) Pub. Date: Oct. 27, 2022

(54) INTELLIGENT VIRTUAL ENVIRONMENT THAT FACILITATES INTEGRATING HYDROLOGY DATA INTO SUBSEQUENT ANALYSES

(71) Applicant: The Alliance Group Enterprise, Inc., Los Angeles, CA (US)

(72) Inventors: Adrian Troncoso, Los Angeles, CA (US); Andre Troncoso, Los Angeles, CA (US)

(21) Appl. No.: 17/715,926

(22) Filed: Apr. 7, 2022

Related U.S. Application Data
(63) Continuation-in-part of application No. 17/096,863, filed on Nov. 12, 2020.
(60) Provisional application No. 62/934,427, filed on Nov. 12, 2019.
(60) Provisional application No. 63/172,064, filed on Apr. 7, 2021.

(51) Int. Cl. G01V 99/00

(52) U.S. Cl. CPC G01V 99/005; G01V 2210/60

(57) ABSTRACT

Aspects directed towards providing an integrated virtual environment (IVE) to facilitate automating the generation of various interval-based analyses is disclosed. In a particular aspect, an input from a user is received in which the input includes hydrology input values corresponding to a desired interval-based analysis associated with at least one mathematical model. The desired interval-based analysis is then performed in accordance with the input from the user.

### CROSS-REFERENCE TO RELATED APPLICATIONS

This application is a continuation-in-part application of U.S. patent application Ser. No. 17/096,863, filed Nov. 12, 2020, entitled “SYSTEM AND METHODOLOGY THAT FACILITATES INTEGRATING HYDROLOGY DATA INTO SUBSEQUENT ANALYSES,” which claims the benefit of U.S. Provisional Patent Application Ser. No. 62/934,427, filed Nov. 12, 2019, entitled “SYSTEM AND METHODOLOGY THAT FACILITATES INTEGRATING HYDROLOGY DATA INTO SUBSEQUENT ANALYSES”. This application also claims the benefit of U.S. Provisional Patent Application Ser. No. 63/172,064, filed Apr. 7, 2021, entitled “INTELLIGENT VIRTUAL ENVIRONMENT THAT FACILITATES INTEGRATING HYDROLOGY DATA INTO SUBSEQUENT ANALYSES”. The entire contents of each of the above applications are incorporated herein by reference.

### TECHNICAL FIELD

The subject disclosure generally relates to the processing of hydrology data, and more specifically to providing an integrated virtual environment (IVE) for performing interval-based hydrological/hydraulic/LID analyses in accordance with jurisdictional standards.

### BACKGROUND

A variety of analyses are routinely performed when designing water drainage projects for municipalities. Such analyses are often performed sequentially, wherein data from a first analysis is used in a subsequent analysis. For instance, the design of water drainage projects often begins with a hydrology analysis, wherein data from the hydrology analysis is subsequently used in a hydraulic analysis. A low impact design (LID) analysis may then be performed using data from the hydrology analysis and/or hydraulic analysis. Performing these analyses with conventional systems, however, undesirably requires users to manually enter data from one analysis into a subsequent analysis, which is prone to human error. Furthermore, because a similar LID may be desired in a geographic region with different jurisdictional standards, an analysis via conventional systems of how the LID impacts this different geographic region undesirably requires users to perform a new sequence of analyses specific to the different jurisdictional standard.

Accordingly, it would be desirable to provide a system and method which overcomes these limitations. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with providing an integrated virtual environment (IVE) for performing interval-based hydrological/hydraulic/LID analyses in accordance with jurisdictional standards. In one such aspect, a method is disclosed which includes receiving an input from a user in which the input includes hydrology input values corresponding to a desired interval-based analysis associated with at least one mathematical model. The method further includes performing the desired interval-based analysis in accordance with the input from the user.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 illustrates an exemplary environment that facilitates integrating hydrology data in accordance with an aspect of the subject specification;

FIG. 2 is a screenshot of an exemplary workspace interface in accordance with an aspect of the subject specification;

FIG. 3 is a screenshot of an exemplary watershed editor in accordance with an aspect of the subject specification;

FIG. 4 is a screenshot of an exemplary subarea editor menu in accordance with an aspect of the subject specification;

FIG. 5 is a screenshot of an exemplary watershed summary menu in accordance with an aspect of the subject specification;

FIG. 6 is a screenshot of an exemplary inlet editor menu in accordance with an aspect of the subject specification;

FIG. 7 is a screenshot of an exemplary vegetated swale menu in accordance with an aspect of the subject specification;

FIG. 8 is a screenshot of an exemplary infiltration trench menu in accordance with an aspect of the subject specification;

FIG. 9 is a screenshot of an exemplary planter box menu in accordance with an aspect of the subject specification;

FIG. 10 is a screenshot of an exemplary capture and reuse menu in accordance with an aspect of the subject specification;

FIG. 11 is a screenshot of an exemplary assign menu in accordance with an aspect of the subject specification;

FIG. 12 is a screenshot of an exemplary drywell editor in accordance with an aspect of the subject specification;

FIG. 13 illustrates a block diagram of an exemplary motorcycle system that facilitates implementing aspects disclosed herein;

FIG. 14 is a flow diagram of a first exemplary methodology that facilitates integrating hydrology data in accordance with an aspect of the subject specification;

FIG. 15 is a flow diagram of a second exemplary methodology that facilitates integrating hydrology data in accordance with an aspect of the subject specification;

FIG. 16 is a flow diagram of an exemplary methodology that facilitates integrating hydrology data within a jurisdictional-driven system in accordance with an aspect of the subject specification;

FIG. 17 illustrates a map corresponding to exemplary analyses summarized in FIGS. 18-27 in accordance with an aspect of the subject specification;

FIGS. 18-27 illustrate tables and diagrams corresponding to various exemplary analyses of the elements illustrated in FIG. 17 in accordance with an aspect of the subject specification;

FIG. 28 is a block diagram representing exemplary non-limiting networked environments in which various embodiments described herein can be implemented; and

FIG. 29 is a block diagram representing an exemplary non-limiting computing system or operating environment in which one or more aspects of various embodiments described herein can be implemented.

### DETAILED DESCRIPTION

### Overview

As discussed in the background, it is desirable to provide a system and method which overcomes the various limitations of conventional water drainage modeling systems. The embodiments disclosed herein are directed towards overcoming such limitations by integrating hydrology data into subsequent analyses (e.g., hydraulic analyses, LID analyses, etc.). For instance, in a particular embodiment, users are provided with a variety of interfaces, which facilitates a seamless and automatic transfer of information from one analysis to a subsequent analysis within a single integrated system. With respect to analyses for particular LID devices, it should be appreciated that utilizing any of a plurality of interfaces and/or programming languages are contemplated (e.g., Java).

Aspects disclosed herein are also directed towards seamlessly switching between analyses requiring compliance with different jurisdictional standards (e.g., City of Los Angeles, County of Los Angeles, Calif. Department of Transportation, etc.). For instance, in an exemplary embodiment, restrictions on user input may be implemented in accordance with a jurisdictional standard selected by the user to ensure that a design generated by the system is indeed valid for that particular jurisdiction. For example, a user may be prompted with an error message and/or otherwise not allowed to perform calculations if input parameters are not within an acceptable range of values for the desired jurisdiction.

The aspects disclosed herein thus desirably provide users with an integrated, user-friendly, and jurisdictional-driven tool that enables the user to expeditiously perform calculations and generate design solutions for a given project. Moreover, by utilizing the system and methodology disclosed herein, the time and amount of human error associated with performing hydrology, hydraulics, and LID analyses is significantly reduced.

It should be appreciated that “hydrology analysis”, as used herein, generally refers to analyses directed towards the impact of rainwater on a given site, wherein such analyses may involve calculating the rate and volume of storm water generated by a given storm event on a site having particular characteristics. Furthermore, as used herein, “hydraulic analysis” generally refers to analyses directed towards devices that direct water from a site into a local channel. An “LID analysis”, as used herein, generally refers to analyses directed towards devices that filtrate rainwater, wherein such analyses may involve the use of different designs and/or products for treating storm flows (e.g., pollutant removal) and filtrating to an underground aquifer, so that the treated water may be reused and/or discharged to a storm drain system. It should thus be appreciated that design parameters for LID and hydraulic devices are generally dependent on parameters derived from a corresponding hydrology analysis.

### Exemplary Environment

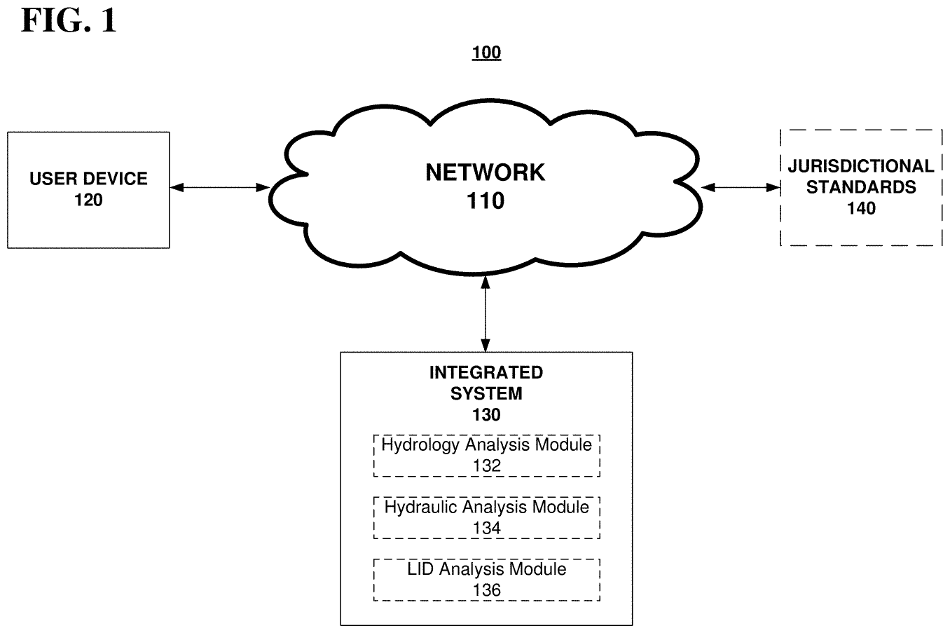

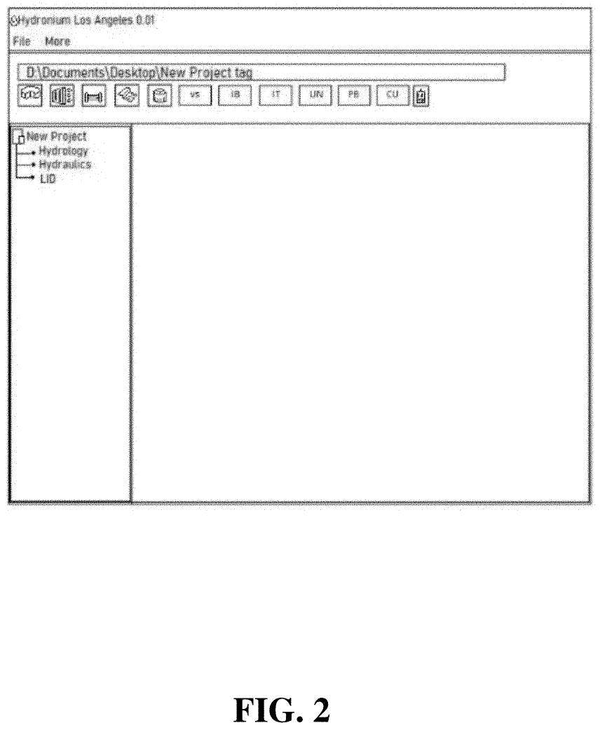

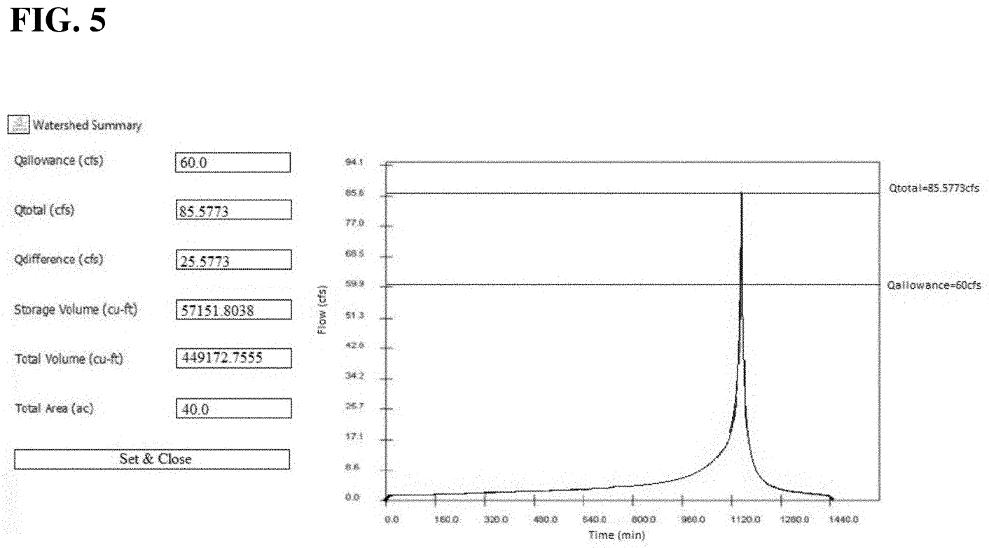

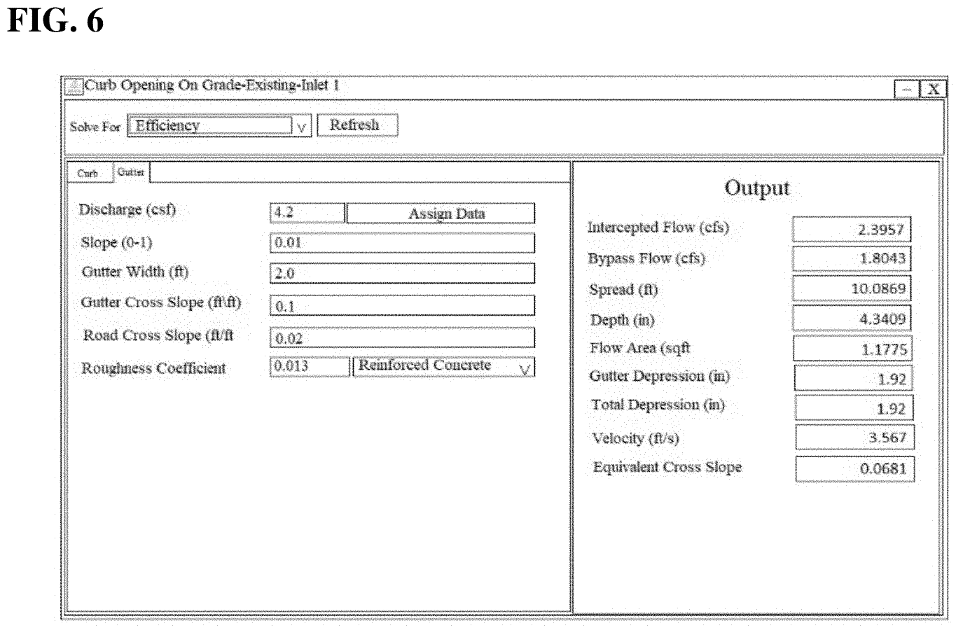

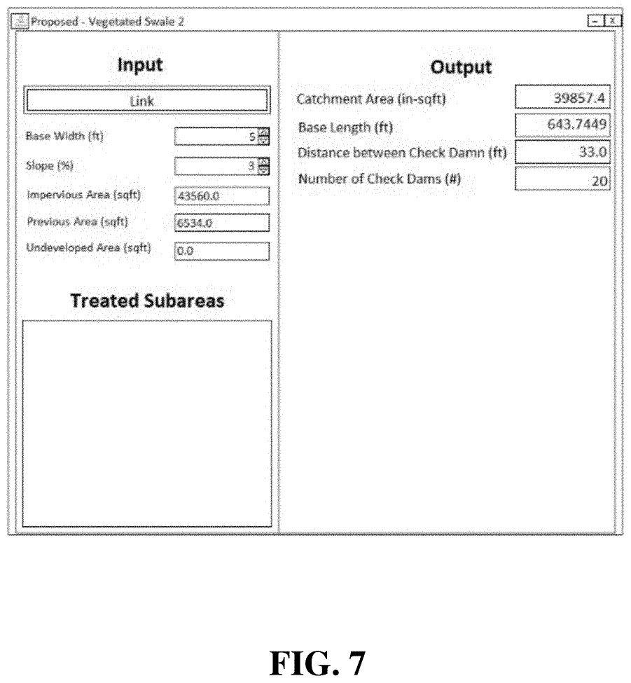

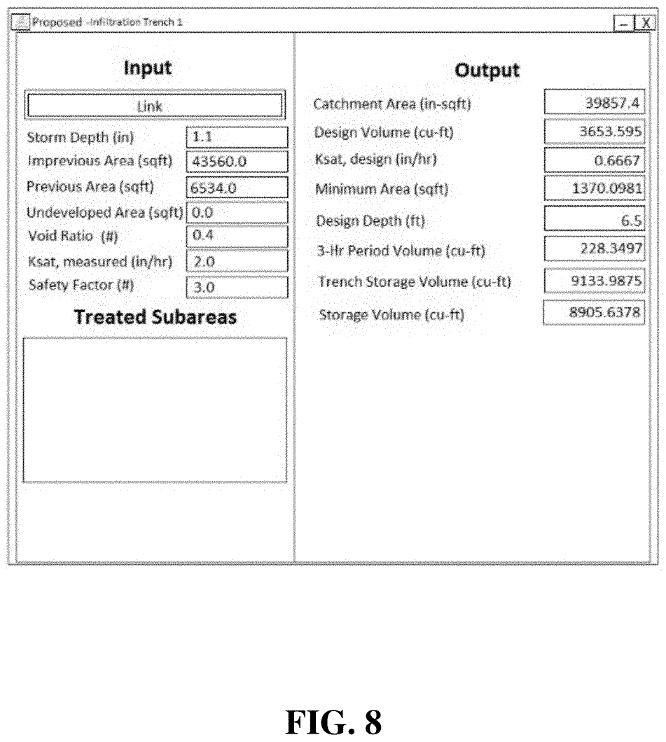

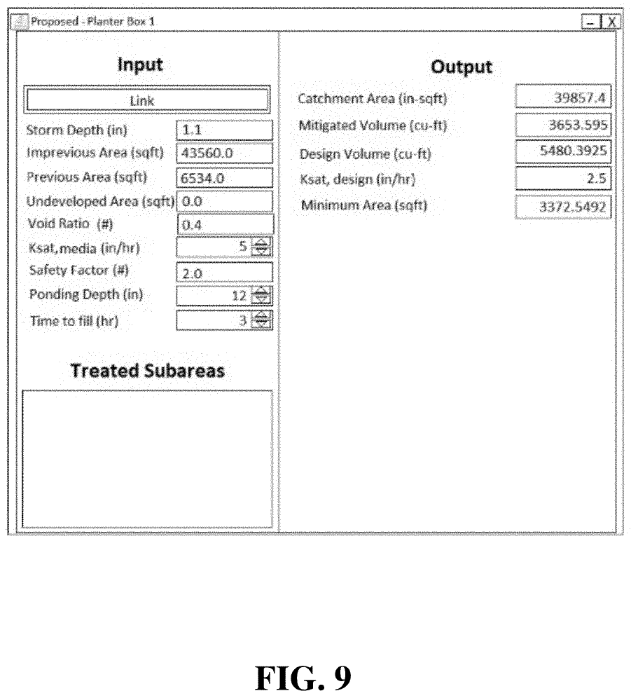

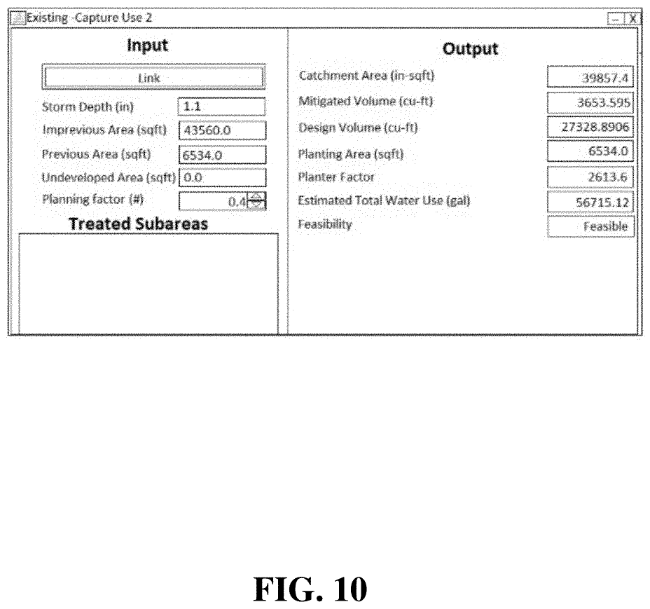

Turning now to FIG. 1, an exemplary environment that facilitates integrating hydrology data into subsequent analyses (e.g., hydraulic analyses, LID analyses, etc.) is provided according to an embodiment. As illustrated, environment 100 includes user device 120, which may be coupled to integrated system 130 and a repository of jurisdictional standards 140 via network 110 (e.g., the Internet). Within such embodiment, it is contemplated that user device 120 (e.g., a personal computer, mobile phone, tablet, etc.) is utilized by a user to communicate with integrated system 130, wherein integrated system 130 is configured to perform any of a plurality of analyses desired by the user. For instance, as illustrated, integrated system 130 may include a hydrology analysis module 132 configured to perform hydrology analyses, a hydraulic analysis module 134 configured to perform hydraulic analyses, and a LID analysis module 136 configured to perform LID analyses. Moreover, it is contemplated that integrated system 130 may be configured to provide users with a variety of interfaces, which facilitate a seamless and automatic transfer of analytic data between any of hydrology analysis module 132, hydraulic analysis module 134, and/or LID analysis module 136. Various exemplary user interfaces in accordance with aspects disclosed herein are provided in FIGS. 2-12. Integrated system 130 may also be configured to seamlessly switch between analyses requiring compliance with different jurisdictional standards, as desired by the user, by retrieving parameters corresponding to any of a plurality of standards stored in the repository of jurisdictional standards 140.

When performing hydrology analyses via conventional systems, it is noted that such systems may begin by requiring users to define various parameters (e.g., project name, subarea id, area, flow path length, flow path slope, 24-hr, 50-yr rainfall depth, percent impervious, soil type, design storm frequency, fire factor, etc.). With conventional systems, it is further noted that outputs are derived which are associated with various criteria (e.g., modeled (50-yr) rainfall depth, peak intensity, undeveloped runoff coefficient, developed runoff coefficient, time of concentration, clear peak flow rate, burned peak flow rate, 24-hr clear runoff volume, 24-hr clear runoff volume, etc.), wherein the outputs may be represented numerically and/or graphically. Undesirably, however, conventional systems for modeling hydrology analyses are unable to perform hydraulic and/or LID calculations. Such systems are also not user-friendly when performing hydrology analyses for multiple geographic regions (multi-subareas), which often requires users to manually re-enter data for a subsequent geographic region that they already entered for a previous geographic region.

With respect to conventional systems for hydraulic analyses, it is noted that none of these systems import data from a hydrology analysis, nor do they enable users to export hydraulic data into a subsequent LID analysis. Regarding the general capability of such systems, it is noted that hydraulic results are typically provided using a set of GUIs (Graphical User Interface) as a catalyst for analysis, wherein various calculations may be performed including, for example, hydraulic channel calculations (e.g., rectangular channel, triangular channel, trapezoidal channel, composite gutter (channel), parabolic channel, irregular channel, etc.), pipe calculations (e.g., pressure pipe, circular pipe, box pipe, elliptical pipe, irregular pipe, etc.), weir calculations (e.g., rectangular weir, v-notch weir, Cipolletti weir, broad crested weir, generic weir, etc.), orifice calculations (e.g., rectangular orifice, circular orifice, and generic orifice), and inlet calculations (e.g., grate inlet in sag, grate inlet on grade, curb inlet in sag, curb inlet on grade, ditch inlet in sag, ditch inlet on grade, slotted drain inlet in sag, slotted drain inlet on grade, combination inlet in sag, combination inlet on grade, etc.).

With respect to the general capabilities of conventional LID systems, it is noted that the ability to process hydrology data is undesirably limited (e.g., limited to hydrograph combining, channel reaching, pond routing, and hydrograph diverting). Such systems are also undesirably limited with respect to calculating hydraulic properties of various devices (e.g., limited to curb opening inlets, grate inlets, combination inlets, drop curb inlets, drop gate inlets, and slotted inlets). Moreover, none of these systems are user friendly with respect to importing data from a hydrology analysis and/or hydraulic analysis into a LID analysis. Conventional LID systems are also customized according to a particular jurisdictional standard, which is undesirable if a LID analysis in compliance with a different jurisdictional standard is required.

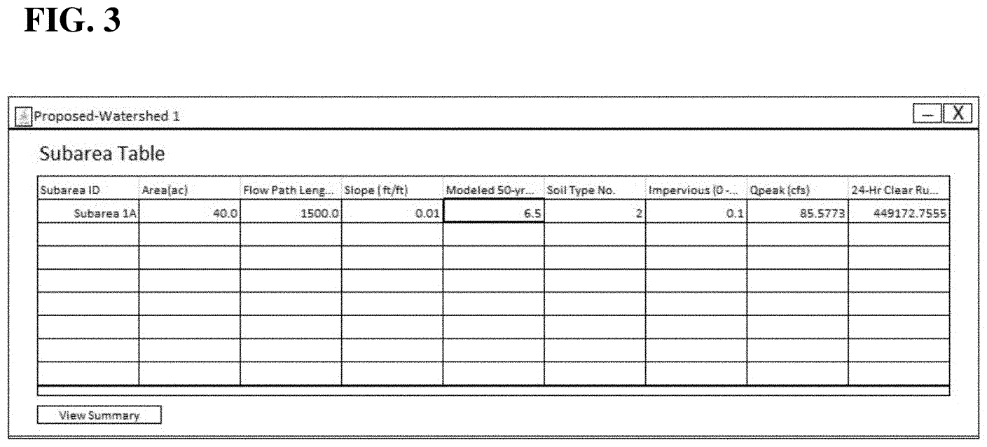

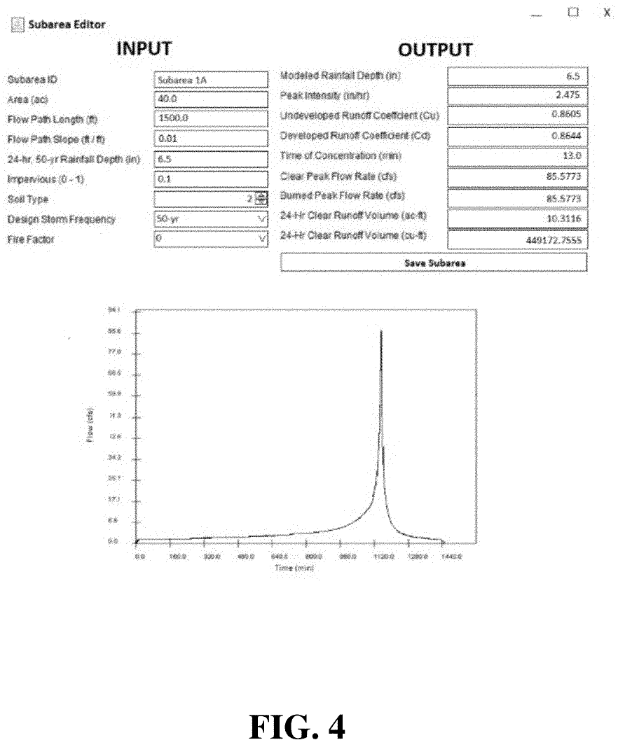

In an exemplary aspect disclosed herein, referring back to FIG. 1, it is contemplated that integrated system 130 may be configured to derive hydrology results in compliance with various standards stored in the repository of jurisdictional standards 140 (e.g., using methods found in the 2006 Hydrology Manual provided by Los Angeles County Public Works (LACPW)). Before adding a watershed (i.e., a drainage study) to a project, a user using integrated system 130, may be presented with a Watershed Setup Menu when clicking a designated Create Watershed Button. From there, the user can select the number of subareas, the ID of the watershed, and the condition of the watershed (existing or proposed), for example. Once the user clicks the Create Watershed Button, the user may be given access to a Watershed Editor Menu (See e.g., FIG. 3). In this menu, every given tributary area (subarea) may be given a row in a Subarea Table which is ensconced by this menu. When the user selects a row of the Subarea Table, the user is presented with a Subarea Editor interface (See e.g., FIG. 4). Here, it should be noted that a watershed entity may comprise many subareas which have input parameters pertaining to a particular storm event and terrain, so a tabular representation of subareas may be desired. A watershed entity is thus analogous to a site since, a hydrology design begins when a site is divided into a set of parcels that are given alpha-numerical labeling with a title “subarea”. According to the City of Los Angeles, for example, a parcel that is used for hydrology analysis is considered a subarea. In the Subarea Editor, the user can insert input information for that given subarea and derive output information by pressing the enter key. Once the user is content with the input and output information, the user can click the Save Subarea Button which results in the aggregation of a new subarea into the Subarea Table.

Here, rather than using a combination box style of input like conventional systems, it is contemplated that a spinner style of input may be more desirable in order to obtain a soil type, for example. Moreover, a unit-hydrograph output is contemplated that is dynamically built from scratch (e.g., using Java) whereas conventional systems use matplotlib which is a prebuilt python library. Another difference from conventional systems is that integrated system 130 may be configured to arrange subareas as rows in a table ensconced by the Watershed Editor. In addition to the instantiation of watershed subareas, the user can derive and view summary data of all watershed subareas via the Watershed Editor by clicking a View Summary Button. From here, the user has access to a summary of input and output parameters of the instantiated subareas via a Watershed Summary Menu, wherein any of various characteristics may be included (e.g., flow allowance (Qallowance), total flow (Qtotal), flow difference (Qdifference), storage volume (Vstorage), total volume (Vtotal), total area (Atotal), etc.). Regarding the Qallowance characteristic, for some embodiments, integrated system 130 may be configured to have this characteristic be the only characteristic a user can manipulate using a text field. Once the user presses the enter key, the Qallowance may be set for that watershed (i.e., set of subareas) and a line designating the Qallowance may be drawn graphically on a summary unit-hydrograph on the Watershed Summary Menu. Additionally, all the other summary characteristics may be derived and displayed for the user. Once the user is content with the watershed, the user can close the Watershed Editor and it can be displayed as a node on a Project Explorer Tree. Here, it should be noted that the ability to set a Qallowance for a watershed and calculate the storage volume that abides to a particular jurisdiction is unique.

In another aspect, it is contemplated that integrated system 130 may be configured to derive hydraulic results for any of various items (e.g., circular pipes, side curb inlets, composite gutter sections, etc.). Regarding circular pipes, the user can access the Pipe Setup menu by clicking on the create pipe button on the Menu Bar. From here, the user can assign a pipe condition (existing or proposed), pipe id, and pipe type. Once the user clicks the Create Pipe Button, an interface may be instantiated which is defined as the Pipe Editor. In the Pipe Editor, the user can manipulate the newly created pipe's inputs which may include any of various criteria (e.g., roughness coefficient (material), normal depth, special dimensions, invert elevation, discharge, etc.). Additionally, in a particular embodiment, the user pipe input is only restricted when the Solve for Combination Box is set to one of the pipe's inputs. For example, if the Solve for Combination Box is set to discharge, then the discharge text field is restricted since the discharge characteristic of the pipe is the motive for calculation.

Once the user presses the enter key, output information is generated according to any of various criteria (e.g., flow area, hydraulic radius, conveyance, top width, discharge flow, headloss, friction slope, static pressure, etc.). Moreover, a cross sectional graphical representation of the flow status in the pipe may be displayed which corresponds to the input information (a form of output information). Here it should be noted that pipe cross-sectional graphics of conventional systems are unable to show the user a real time graphic and also requires the user to undesirably use different GUIs. Conventional systems are also undesirably inconsistent with respect to outputs since the number of pipe outputs may vary in the amount of detail provided. For example, with conventional systems a user may be required to enter the following criteria: section type, bottom value, side slope, diameter, invert elevation, slope, roughness coefficient, computation type. Then, the user may be required to define the number of desired iterations which results in different sets of outputs depending on the computation type (e.g., flow vs water level depth). From here, if the user wants a precise set of outputs, they must increase the number of iterations which requires several clicks to accomplish. Thus, conventional systems differ from integrated system 130 in the sense that iterations are considered inputs to arrive at a variety of results.

Concerning inlets, integrated system 130 may be configured to create an inlet object in the project which is displayed by the project tree. In a particular embodiment, this can only be done if the user defines a particular set of criteria (e.g., ID, condition, type, flow condition) and clicks the Create Inlet Button. From here, the user can adjust the solving variable via the Solve for Combination Box. The user may then be allowed to solve for inlet efficiency and/or opening dimensions, for example. Below the Solve for Combination Box, the user can manipulate input variables depending on the setting of the Solve for Combination Box. Once the user presses the enter key, a set of output characteristics may be generated giving the user insight on an inlet's current state. Inlet output criteria may include any of various criteria including, for example, intercepted flow, bypass flow, spread, flow area, and average flow velocity.

Pertaining to catch basins, integrated system 130 may be configured to size a catch basin based on any of various criteria (e.g., flow depth, road slope, width, etc.). When creating a catch basin, the user may click the Create Catch Basin button to open the Catch Basin Setup Menu. From here, the user can define the ID and the condition of the catch basin. Then, by clicking the Create Catch Basin Button the user is given access to the Catch Basin Editor where they can choose the inlet and the outlet of the catch basin. Inlets and outlets are limited to existing project pipes and inlets. Additionally, once the user has defined the inlets and outlets of the newly instantiated catch basin, the curb face of the catch basin can be defined via a text field. Once the user presses the enter key, a minimum depth for the catch basin may be calculated.

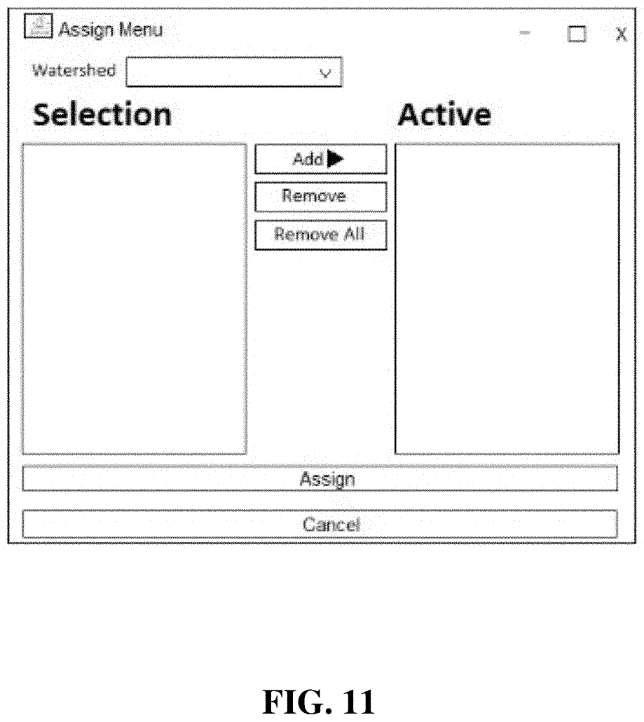

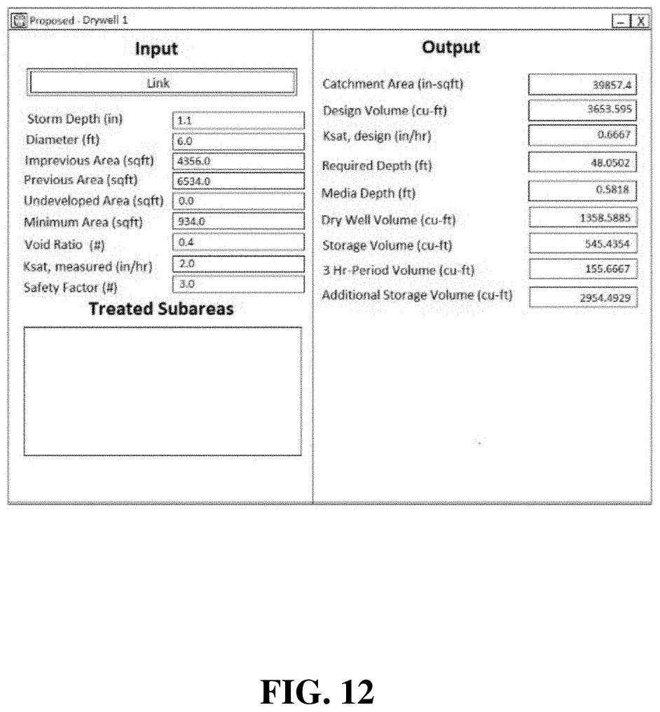

In another exemplary aspect disclosed herein, with respect to LID analyses, it is contemplated that integrated system 130 may be configured to calculate for any of various devices including, but not limited to, the following: dry wells, vegetated swales, infiltration basins, infiltration trenches, biofiltration underdrains, planter boxes, capture & use devices, etc.). Such devices may be defined by a municipality (e.g., the City of Los Angeles) as “best method practices” or BMPs for short, wherein a BMP may generally be defined as a technique, measure, or structural control that is used for a given set of conditions to manage the quantity and improve the quality of stormwater runoff in a cost effective manner. An important role of a BMP is to treat and direct rain water from a given site. In regards to dry wells, the user can aggregate a dry well to the project by clicking the Add Dry Well Button. Once the button has been clicked, the Dry Well Setup Menu (See e.g., FIG. 12) is showed ensconced in the Main Interface (See e.g., FIG. 2). From the Dry Well Setup Menu, the user can define the ID and condition for a new dry well. Then, once the user clicks the Create Dry Well Button a dry well with the predefined ID and condition is added to the project tree. Moreover, the Dry Well Editor is displayed inside the Main Interface which allows the user to manipulate any of various input criteria (e.g., storm depth, diameter, impervious area, pervious area, undeveloped area, minimum area, void ratio, measured infiltration rate (Ksat, measured), safety factor, etc.). Once the user is satisfied with the current status of the inputs, the user can press the enter key to derive and display results that may include any of various items (e.g., catchment area, design volume, designed infiltration rate (Ksat, designed), required depth, media depth, dry well volume, storage volume, 3-hr period volume, additional storage volume, etc.). In order to speed up the input process, integrated system 130 may be configured to provide users with an option to integrate information from hydrology analyses using the Assign Menu (See e.g., FIG. 11). In the assign menu, the user can add subareas into an active list which be used to calculate inputs for a desired dry well by clicking the Apply & Close Button.

With respect to vegetated swales, the user can aggregate a vegetated swale study to a project by clicking the Add Vegetated Swale Button. From this point, a setup menu (Vegetated Swale Setup Menu) may be shown to a user to define an ID and a condition for a new vegetated swale. Once the user is content with the information, the user can click the Create Vegetated Swale Button which aggregates the new swale into the project via the Project Tree and the vegetated swale for that new swale is displayed. From the perspective of the Vegetated Swale Editor, a user can define any of various input criteria (e.g., base width, slope, impervious area, pervious area, undeveloped area, etc.). Then, by clicking the enter key, the user may be provided with instantaneous results of any of various items (e.g., catchment area, base length, distance between check dams, number of check dams, etc.). Here, it should be appreciated that these input and output criteria may be defined and calculated in accordance with any of various jurisdictional standards (e.g., the City of Los Angeles Low Impact Design Manual). One way this may be implemented is in the constraints that the design may assert on the user pertaining to the input fields of base width and slope, for example. Moreover, the user may be limited to a particular range defined by a desired jurisdictional standard (e.g., the City of Los Angeles). In addition to jurisdiction-wide consensus, a user can reduce the time it takes to enter input information using the Assign Menu. The methodology that allows a user to enter hydrology information in the Dry Well Editor may be consistent throughout all LID devices, for example. Next, the infiltration basin can be added in similar fashion by clicking the Add Infiltration Button in the Main Interface. A menu may then be shown to the user, asking for an ID and a condition for a new Infiltration Basin. Once the user is satisfied with entries in the setup menu, the user can click the Create Infiltration Basin Button which results in the aggregation of node (with the ID of the setup menu entry) into the Project Tree and the deployment of the Infiltration Basin Editor. From the Infiltration Basin Editor, the user can define any of various criteria (e.g., storm depth, impervious area, pervious area, undeveloped area, measured infiltration rate (Ksat, measured), safety factor, etc.). Then, by pressing the enter key, the user is provided with instantaneous results that may include any of various items (e.g., catchment area, design volume, design infiltration rate (Ksat, designed), minimum area, design depth, storage volume, etc.).

Additionally, the user may be able to integrate hydrology information as inputs using the Assign Menu. Regarding infiltration trenches, the user can add an infiltration trench to their project by clicking the Add Infiltration Trench Button. The user may then be provided a setup menu (Infiltration Trench Setup Menu) that allows the user to define an ID and condition for a new infiltration trench. Once the user is content with their entries, the user can click the create Infiltration Trench Button which aggregates a node (with an identical ID as the entered in the setup menu) into the Project Tree and the Infiltration Trench Editor is deployed into the Main Interface. In the Infiltration Trench Editor, it should be appreciated that the user can enter any of various criteria (e.g., storm depth, impervious area, undeveloped area, void ratio, measured infiltration rate, safety factor, etc.). Once the user is content with the entries, the user can hit the enter key which results in the generation of any of various outputs (e.g., catchment area, design volume, design infiltration rate (Ksat, designed), minimum area, design depth, 3-hr period volume, trench storage volume, storage volume, etc.). Relating to the integration feature for the Infiltration Trench Editor, a user can import information for they hydrology study like steps found in the dry well, infiltration basin, and other LID assign menus.

Integrated system 130 may also be configured to provide users with a biofiltration underdrain feature. For instance, a user can create a biofiltration underdrain by clicking the Add Biofiltration Underdrain Button that can be found in the top side of the Main Interface. Once clicked, the user is given access to a setup menu (Biofiltration Underdrain Setup Menu) which allows the user to define an ID and a condition for a new biofiltration underdrain. Then, clicking the Create Biofiltration Underdrain Button aggregates a new node (with the id entry of the setup menu) into the Project Tree and deploys the Biofiltration Underdrain Editor. In the Biofiltration Underdrain Editor, the user can define any of various criteria (e.g., storm depth, impervious area, pervious area, undeveloped area, void ratio, measured infiltration rate (Ksat, measured), safety factor, ponding depth, time to fill, etc.). Then, by pressing the enter key, the user is provided with instantaneous results that may include any of various items (e.g., catchment area, mitigated volume, design volume, designed infiltration rate (Ksat, design), minimum area, etc.). Additionally, if the user has conducted a hydrology study beforehand, they can import that information into the Biofiltration Underdrain Editor using the Assign Menu.

Integrated system 130 may also be configured to provide users with a planter box feature. For instance, the user can add a planter box by clicking the Add Planter Box Button. Once clicked, the user is provided access to a setup menu (Plater Box Setup Menu) that allows the user to define an ID and a condition for a new planter box. Then, once content with the entries, the user can click the Create Planter Box Button which results in an aggregation of a node (with the same ID as the entry in the setup menu) into the Project Tree simultaneously with the deployment of the Planter Box Editor. In the Planter Box Editor, the user is able to define any of various criteria (e.g., storm depth, impervious area, pervious area, undeveloped area, void ratio, media infiltration rate (Ksat, media), safety factor, ponding depth, time to fill, etc.). Then, by pressing on the enter key, the user is provided with instantaneous results of any of various items (e.g., catchment area, mitigated volume, designed infiltration rate (Ksat, design), minimum area, etc.). Here, it should be noted that a user may be desirably constrained by a set of parameters corresponding to a particular jurisdictional standard (e.g., media infiltration rate, ponding depth, time to fill, etc.).

A Capture & Use feature is also contemplated, wherein the user can add a capture & use device into their project by clicking the Add Capture & Use Device Button. Once clicked, the user can assign an ID and a condition through a set of text fields. Once content with the entries, the user can click the Create Capture & Use Button which results in the aggregation of a node in the Project Tree and the deployment of the Create & Capture Editor. In the Create & Capture Editor, the user can define any of various criteria (e.g., storm depth, impervious area, pervious area, undeveloped area, planting factor, etc.). Furthermore, once the user presses the enter key, a set of results is displayed in the editor that may include any of various items (e.g., catchment area, mitigated volume, design volume, planting area, planter factor, estimated total water use, feasibility, etc.). In similar fashion, the user can integrate information from hydrology analysis of the program by using the Assign Menu.

Integrated system 130 may also be configured to create any of various reports (e.g., hydrology reports, pipe reports, catch basin reports, LID reports, etc.) by clicking the Create Report Button. Here, the user may be presented with any of various criteria via an interface called the Report Menu, wherein such criteria may include, company name, designer name, version tag, company logo, report type, etc., for example. Once the user has filled out the aforementioned criteria, the file navigation menu is displayed. Then, the user can decide what to name the report file and where to put the report file. Automatically, the defined criteria that was set originally by the user in the Report Menu is placed as a cover sheet for all report types. With respect to saving, the user can save all analysis work saved as a .tag file, for example. Moreover, the user can access that saved information via the Main Interface's menu item entitled File. Once the File Menu Item is clicked, a drop-down menu is provided which may include any of various items (e.g., new project, save, save as, open, exit, etc.). Once the user clicks the open item, the user is provided with a file navigator menu where they can select their saved work file. Then, by clicking the open button of the file navigator, the user is given access to the saved work.

### Exemplary Embodiments

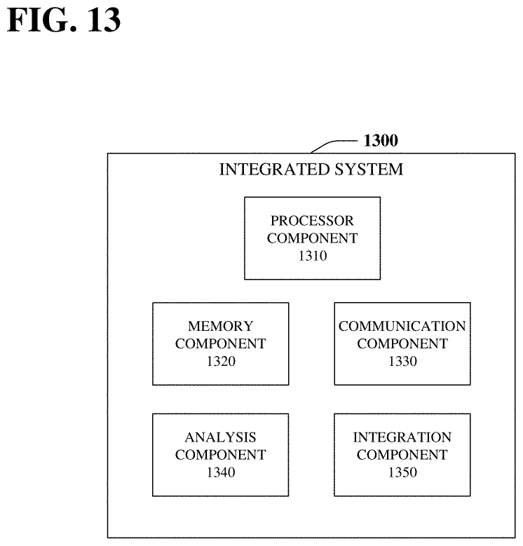

Referring next to FIG. 13, an exemplary block diagram of a system configured to integrate hydrology data in accordance with aspects disclosed herein is provided. As illustrated, integrated system 1300 may include a processor component 1310, a memory component 1320, a communication component 1330, an analysis component 1340, and an integration component 1350. Components 1310-1340 may reside together in a single location or separately in different locations in various combinations, including, for example, a configuration in which at least one of the aforementioned components reside in a cloud. It should also be appreciated that integrated system 1300 is substantially similar to integrated system 130 illustrated in FIG. 1.

In one aspect, processor component 1310 is configured to execute computer-readable instructions related to performing any of a plurality of functions. Processor component 1310 can be a single processor or a plurality of processors which analyze and/or generate information utilized by memory component 1320, communication component 1330, analysis component 1340, and/or integration component 1350. Additionally, or alternatively, processor component 1310 may be configured to control one or more components of integrated system 1300.

In another aspect, memory component 1320 is coupled to processor component 1310 and configured to store computer-readable instructions executed by processor component 1310. Memory component 1320 may also be configured to store any of a plurality of other types of data including data generated by any of communication component 1330, analysis component 1340, and/or integration component 1350. Memory component 1320 may be configured to store any of several types of information explained above, including parameters corresponding to any of various jurisdictional standards, for example.

Memory component 1320 can be configured in a number of different configurations, including as random-access memory, battery-backed memory, Solid State memory, hard disk, magnetic tape, etc. Various features can also be implemented upon memory component 1320, such as compression and automatic back up (e.g., use of a Redundant Array of Independent Drives configuration). In one aspect, the memory may be located on a network, such as a “cloud storage” solution.

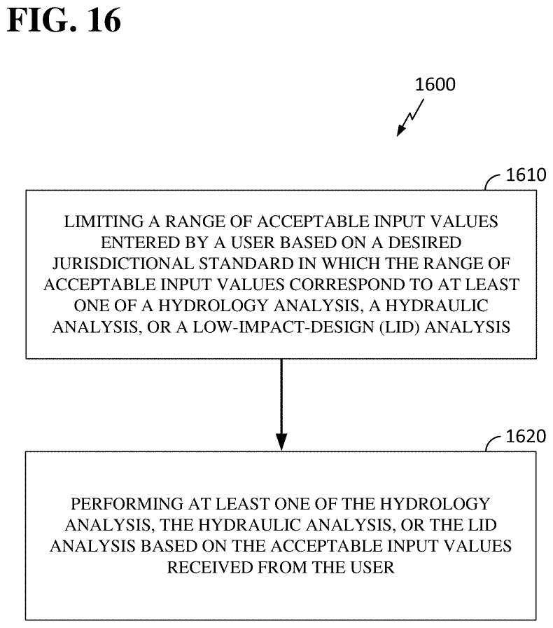

Communication component 1330 may be used to interface integrated system 1300 with external entities. For example, communication component 1330 may be configured to receive and/or transmit data via a network (See e.g., FIG. 16). In a particular embodiment, communication component 1330 is configured to receive an input from a user, wherein the input includes hydrology input values associated with a plurality of hydrology parameters corresponding to a hydrology analysis performed by analysis component 1340. Integration component 1350 may then be configured to auto-populate a plurality of hydraulic parameters corresponding to a hydraulic analysis with hydrology values retrieved from the hydrology analysis. For example, the hydrology values retrieved from the hydrology analysis may include the hydrology input values received from the user and/or hydrology output values generated by the hydrology analysis.

It is also contemplated that communication component 1330 may be configured to receive other types of hydrology input values from the user. For example, the hydrology input values received from the user may include a jurisdictional standard selection, wherein integration component 1350 is then be configured to auto-populate the plurality of hydraulic parameters consistent with the jurisdictional standard selection. The hydrology input values received from the user may also include a first set of hydrology values associated with a first geographical region and a second set of hydrology values associated with a second geographical region, wherein integration component 1350 is then be configured to auto-populate the plurality of hydraulic parameters with a first set of hydraulic parameters associated with the first geographical region and a second set of hydraulic parameters associated with the second geographical region.

In another aspect of the disclosure, integrated system 1300 may be configured to generate a hydrology output corresponding to the hydrology analysis, wherein the hydrology output includes a graphical representation of at least one of a Q-allowable or a volume storage requirement. Similarly, integrated system 1300 may be configured to generate a hydraulic output corresponding to the hydraulic analysis, wherein the hydraulic output includes a graphical representation of at least one of a Q-allowable or a volume storage requirement.

In yet another aspect of the disclosure, integration component 1350 may be configured to auto-populate a plurality of low-impact-design (LID) parameters corresponding to an LID analysis with at least one of the hydrology values retrieved from the hydrology analysis (e.g., hydrology input values received from the user and/or hydrology output values generated by the hydrology analysis) or hydraulic values retrieved from the hydraulic analysis (e.g., hydraulic input values received from the user and/or hydraulic output values generated by the hydraulic analysis). Within such embodiment, integration component 1350 may then be further configured to auto-populate the plurality of LID parameters consistent with a jurisdictional standard selection from the user. Integration component 1350 may also be configured to auto-populate the plurality of LID parameters with a first set of LID parameters associated with a first geographical region selected by the user and a second set of LID parameters associated with a second geographical region selected by the user.

An optimization of the LID analysis is also contemplated. Within such embodiment, integrated system 1300 may be configured to optimize at least one of the plurality of LID parameters, wherein the optimizing comprises enabling the user to vary an LID value corresponding to the at least one the plurality of LID parameters. For example, integrated system 1300 may be configured to limit a range of possible values for the LID value in accordance with a desired output for at least one of the hydrology analyses, the hydraulic analysis, or the LID analysis. Within such embodiment, integrated system 1300 may be configured to limit the range of possible values for the LID value so that the desired output is in compliance with a desired jurisdictional standard, for example.

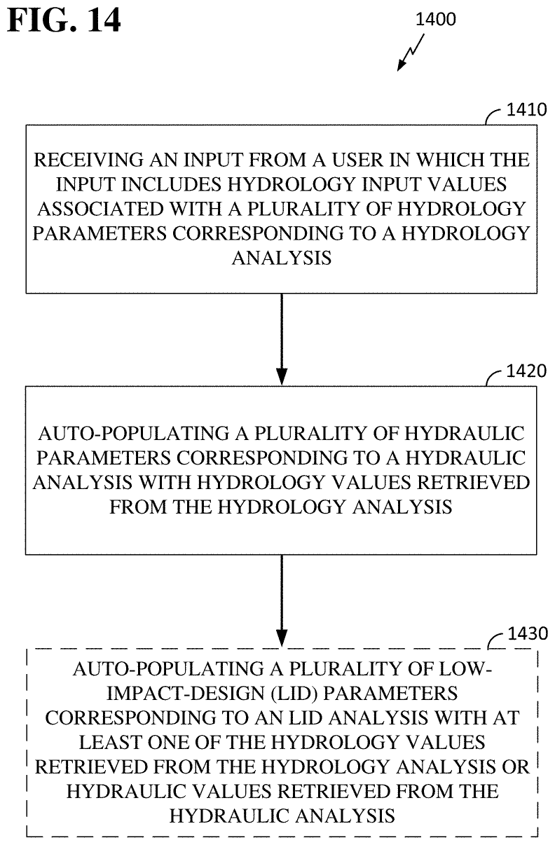

Referring next to FIG. 14, a flow diagram of a first exemplary methodology that facilitates integrating hydrology data is provided in accordance with an aspect of the subject specification. As illustrated, process 1400 includes a series of acts that may be performed by an integrated system (e.g., integrated system 130 or integrated system 1300) that includes at least one computing device according to an aspect of the subject specification. For instance, process 1400 may be implemented by employing a processor to execute computer executable instructions stored on a computer readable storage medium to implement the series of acts. In another embodiment, a computer-readable storage medium comprising code for causing at least one computer to implement the acts of process 1400 is contemplated.

As illustrated, process 1400 begins at act 1410 with the integrated system receiving an input from a user in which the input includes hydrology input values associated with a plurality of hydrology parameters corresponding to a hydrology analysis. At act 1420, process 1400 proceeds with the integrated system auto-populating a plurality of hydraulic parameters corresponding to a hydraulic analysis with hydrology values retrieved from the hydrology analysis. For some embodiments, process 1400 may further comprise act 1430 where the integrated system auto-populates a plurality of LID parameters corresponding to an LID analysis with at least one of the hydrology values retrieved from the hydrology analysis or hydraulic values retrieved from the hydraulic analysis.

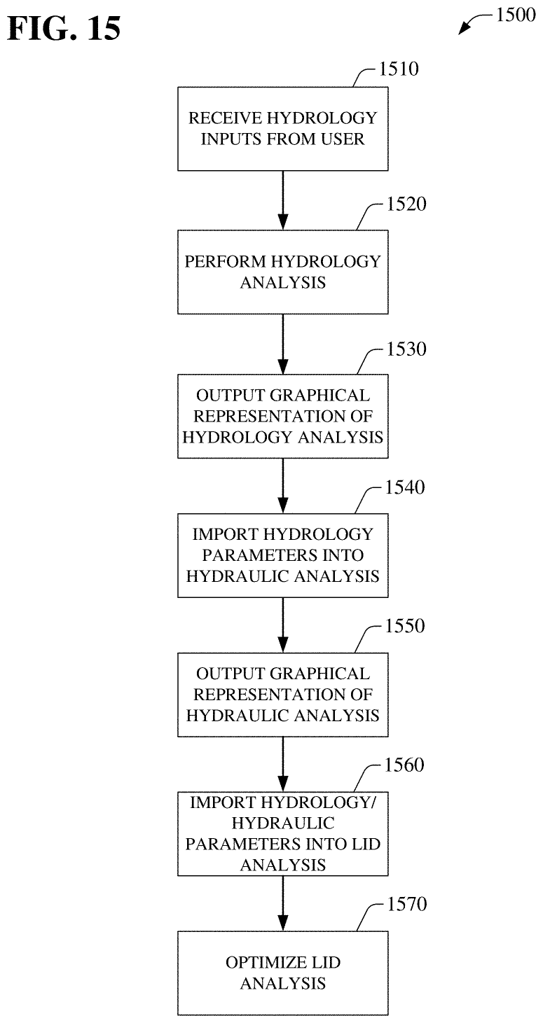

Referring next to FIG. 15, a flow diagram of a second exemplary methodology that facilitates integrating hydrology data is provided in accordance with an aspect of the subject specification. As illustrated, similar to process 1400, process 1500 includes a series of acts that may be performed by an integrated system (e.g., integrated system 130 or integrated system 1300) that includes at least one computing device (e.g., integrated system 130 or integrated system 1300) according to an aspect of the subject specification. For instance, process 1500 may be implemented by employing a processor to execute computer executable instructions stored on a computer readable storage medium to implement the series of acts. In another embodiment, a computer-readable storage medium comprising code for causing at least one computer to implement the acts of process 1500 is contemplated.

As illustrated, process 1500 begins with the integrated system receiving hydrology inputs from a user at act 1510. At act 1520, the integrated system then performs a hydrology analysis, followed by the integrated system outputting a graphical representation of the hydrology analysis at act 1530. As previously stated, it is contemplated that such output may include a graphical representation of at least one of a Q-allowable or a volume storage requirement corresponding to the hydrology analysis.

At act 1540, process 1500 proceeds with the integrated system importing hydrology parameters from the hydrology analysis performed at act 1520 into a hydraulic analysis. The integrated system then outputs a graphical representation of the hydraulic analysis at act 1550. Here, similar to the graphical representation generated in act 1530, it is contemplated that the output generated at act 1550 may include a graphical representation of at least one of a Q-allowable or a volume storage requirement corresponding to the hydraulic analysis.

At act 1560, the integrated system then imports parameters into an LID analysis. For instance, the integrated system may import hydrology parameters from the hydrology analysis and/or hydraulic parameters from the hydraulic analysis. Process 1500 then concludes at act 1570 with the integrated system optimizing the LID analysis according to LID parameters selected by the user. For example, act 1570 may include limiting a range of possible values for a particular LID value so that the desired output is in compliance with a desired jurisdictional standard, for example.

In another aspect disclosed herein, it is contemplated that integrated system 1300 may be configured as a jurisdictional-driven system, wherein the user is prompted with a red flag and/or not allowed to perform calculations if input values are outside of an acceptable range of values for a particular jurisdiction. For instance, communication component 1330 may be configured to limit a range of acceptable input values entered by a user based on a desired jurisdictional standard (e.g., where the range of acceptable input values correspond to at least one of a hydrology analysis, a hydraulic analysis, or an LID analysis). Analysis component 1340 may then be configured to perform at least one of a hydrology analysis, a hydraulic analysis, or an LID analysis based on the acceptable input values received from the user.

When configured as a jurisdictional-driven system, it is contemplated that integrated system 1300 may encompass various additional aspects. For instance, communication component 1330 may be configured to enable the user to select the desired jurisdictional standard from a plurality of candidate jurisdictional standards (e.g., via a search tool, pull-down menu, etc.).

With respect to limiting the range of acceptable input values, various embodiments are also contemplated. For instance, communication component 1330 may be configured to prompt the user to enter a different value when an input value entered by the user is outside of the range of acceptable input values (e.g., via an error message when the input is entered, rather than waiting for the analysis to be performed). In another aspect disclosed herein, since different jurisdictions may require different sets of parameters, communication component 1330 may be configured to auto-populate parameters, wherein the particular set of parameters displayed to the user are consistent with the specific jurisdictional standard selected by the user.

It is also contemplated that the limiting of acceptable input values can be integrated across different analyses. For instance, communication component 1330 may be configured to limit a range of acceptable hydraulic input values based on the desired jurisdictional standard and hydrology values retrieved from the hydrology analysis. Similarly, communication component 1330 may be configured to limit a range of acceptable LID input values based on the desired jurisdictional standard and at least one of hydrology values retrieved from the hydrology analysis or hydraulic values retrieved from the hydraulic analysis.

Referring next to FIG. 16, a flow diagram of an exemplary methodology that facilitates integrating hydrology data within a jurisdictional-driven system is provided in accordance with an aspect of the subject specification. As illustrated, process 1600 includes a series of acts that may be performed by an integrated system (e.g., integrated system 130 or integrated system 1300) that includes at least one computing device according to an aspect of the subject specification. For instance, process 1600 may be implemented by employing a processor to execute computer executable instructions stored on a computer readable storage medium to implement the series of acts. In another embodiment, a computer-readable storage medium comprising code for causing at least one computer to implement the acts of process 1600 is contemplated.

As illustrated, process 1600 begins at act 1610 with the integrated system limiting a range of acceptable input values entered by a user. Here, it should be appreciated that the limiting is based on a desired jurisdictional standard in which the range of acceptable input values correspond to at least one of a hydrology analysis, a hydraulic analysis, or an LID analysis. At act 1620, process 1600 then concludes with the integrated system performing at least one of the hydrology analysis, the hydraulic analysis, or the LID analysis based on the acceptable input values received from the user.

### Exemplary Intelligent Virtual Environment

In another aspect disclosed herein, an intelligent virtual environment (IVE) is contemplated to facilitate automating the generation of interval-based hydrological/hydraulic/LID analyses in accordance with jurisdictional standards. Moreover, a software solution is contemplated that provides interval-based results of mathematical models for local jurisdictions and independent researchers.

For instance, with the IVE solution disclosed herein users are given tools to build custom models that represent the standards and constraints of their local jurisdiction. If a user is not satisfied with the catalog of models provided by IVE, for example, a math suite is provided where they may construct custom models that will fit the needs of their particular project. This customization extends to reporting as well where the format may vary by jurisdiction. For example, the Caltrans format for organizing hydrologic and hydraulic information may not be compatible with the counties throughout the state of California.

With regards to the modeling tools that may be provided by IVE, it is contemplated that models may be represented by a plurality of nodes that are connected to each other through a predecessor-successor relationship. For instance, these nodes may be based on the IEEE definition of requirement traceability which states: predecessor-successor relationship between two or more nodes, upward derivation paths and flow down of the work node hierarchy, it establishes the reason for a node to exists, and discernable relationships between two or more logical entities.

In a particular aspect disclosed herein, IVE utilizes an inlet spacing table algorithm which may facilitate automating the generation of hydrology and hydraulics report in accordance with particular jurisdictional standards (e.g., CalTrans). Here, unlike conventional solutions, it should be noted that IVE produces a table based on groups of system elements for hydrology and hydraulics that abide by the particular jurisdictional standards desired by the user. It should be further noted that IVE may be configured to sort tributary areas and their respective inlets (e.g., from first to last). For instance, the first tributary area of a run may be placed at the top of the table rather than some random position within the table, wherein a “run” is defined as a chain of tributary area elements that are predecessors to inlet elements. Hence, a chain ends when there is no predecessor-successor relationship between the beginning tributary area and another tributary area.

In another aspect disclosed herein, a variation of the Brent-Dekker method to locate the roots of a function is disclosed. In a particular embodiment, IVE calculates the total spread and depth for a Caltrans-defined inlet based on this variation of the Brent-Dekker method, wherein this variation desirably reduces the number of steps of arriving to an approximate solution by starting at the maximum horizontal value possible and working towards negative infinity. Comparatively, the method used by conventional systems require an extra step that involves finding maximums and minimums that impose an undesirable cost on hardware. This impact on the hardware is highlighted by Table 1 below where the number of iterations to arrive at a solution is much less and thus faster with IVE due to the lower complexity of the computations (e.g., IVE does not have to look up the V-Table for addresses of its constituent members).

TABLE 1

| IVE | Conventional Systems |
|---|---|
| Uses functional programming to | Uses OOP to calculate the |
| calculate total spread and depth | total spread and depth |
| which is many times faster than | which is much slower than |
| object-oriented programming (OOP) | functional programming |
| Iteration limit of 100 | Iteration limit of 200 |
| Looping technique to arrive at | Regression technique to |
| a bracket | arrive at a bracket |
| Uses less loops | Uses more loops |

In an exemplary implementation, the dynamic system disclosed herein is a C++/C object that is composed of label, duration, time increment, time array, and elements. Here, it should be appreciated that a “label” may be a string of UTF-8 characters that represents the name of the system. For instance, a dynamic system may be named after the project since a reviewer may prefer designs that are comprehensive of all the impacted locations of the project. It should also be appreciated that a “duration” may be a decimal value that represents the amount of simulation time allotted for the dynamic system, whereas a “time increment” that separates two points of times may be defined within the program as a decimal value. Additionally, a “time array” may include all the time values from zero to the end of a simulation that will be determinant of the type of result generated at the output. And finally, it should be appreciated that the dynamic system “elements” may have references to their predecessors (parents) and successors (children) using pointers. If a user has either a reference or a pointer of an element, for instance, the user may extract the information pertaining to that element and perform actions on its children and parents by calling members, which allows for the identification of successor-predecessor relationships for reporting algorithms.

It is also contemplated that the dynamic system elements disclosed herein can perform at least the following actions: compute results, set the label, add a parent, add a child, remove a parent, remove a child, set the duration, set a time increment, retrieve a pointer to a parent, retrieve a pointer of a child, retrieve a reference of children, retrieve a reference of parents, retrieve an input, retrieve an output, retrieve the time array, retrieve a label, retrieve a time increment, check if the passed pointer is a child, check if the passed pointer is a parent, check if the passed pointer is a descendent, check if the passed pointer is ancestor, retrieve the descent level, and retrieve the ascent level. It is also contemplated that each element can either inherit the simulation time generated by the dynamic system or generate its own time by processing the values for the time increment and duration.

In an exemplary implementation, an input may be a C/C++ object that has a string of UTF-8 characters representing its label and a pointer that points to a value within an array of data. For example, such data can be at least any of the following data types: double, single, 8-bit integer 16-bit integer, 32-bit integer, or a Boolean. Similarly, and output may be a C/C++ object that has an identical label to the input and identical pointer to a value within an array of data. However, it should be noted that the output may have a plurality of pointers that point to an address in memory where an input is located. Moreover, the output objects may have references to input objects enabling it to transfer its data onto the input objects by assigning the data pointers of the input objects to the output object's data pointer. Hence, the dynamic system can transfer the output data of interest throughout the flow-down path. It should thus be noted that, in addition to enabling the information to travel from highest order predecessor to lowest level successor, the system may also compute the incoming information of each element before transferring its output information to its successor.

With regards to implementing CalTrans-specific elements, the ration method can be computed by defining the following parameters: total area, impervious area, pervious area, developed runoff coefficient, undeveloped runoff coefficient, precipitation intensity, time of concentration, and/or storm duration. Based on these defined input parameters, the following output parameters may be generated: composite runoff coefficient, modified composite runoff coefficient, runoff, and peak runoff, wherein a “runoff” represents the sheet flow of water coming from the tributary area, and wherein such runoff may be routed towards the mouths of the inlets by using grading techniques.

Another way to describe grading techniques would be the strategic displacement of soil that allows gravity to direct the flow of water for catchment, wherein the relationship between the tributary and its inlets may be modeled using the dynamic system disclosed herein. Here, it should be noted that IVE can desirably simulate across different points of time, whereas conventional systems can only perform one calculation for one point in time that represents the worst-case scenario. Since the worst-case scenario can often be held for a significant amount of time, it should be noted that such interval-based analysis is preferred (and often requested) by reviewers to ensure public safety. This can be achieved using IVE, in part, because it abides by the IEEE standards of requirements traceability. For instance, the derivation process can be flowed going upward in the parent-child relationship and the computations can be performed by starting at the element with no parent and working downwards.

Additionally, the difference between the bracketing methods of conventional systems and IVE can be explained briefly since the major descriptor of the Brent-Dekker method performed by conventional systems is done by including a bracketing calculation that utilizes software objects of agents rather than methods to perform the computation. In other words, the bracketing mechanism used by conventional systems requires Object-Oriented Programming (OOP) to produce results for many of the elements for the jurisdiction of Caltrans. Conversely, IVE uses a while-loop and iteration limit to ensure that the number of steps to bracket is under 100 iterations, for example. Conventional systems, however, have an iteration limit of 200 and use OOP to accomplish the same task. Comparatively, the functions used by IVE are many times more efficient than OOP methods since they require less jump, return, and lookup instructions.

It should also be noted that some jurisdictions, like Caltrans, have specific standards regarding inlet spacing computation sheets or tables. However, none of the solutions currently available in the market have an effective method to automate the tabulation process. IVE, on the other hand, automates this process by traversing through the parent-child relationships and groups them by type. Then, the tributary areas are associated with the inlets using a hash map and later placed into a table for PDF print.

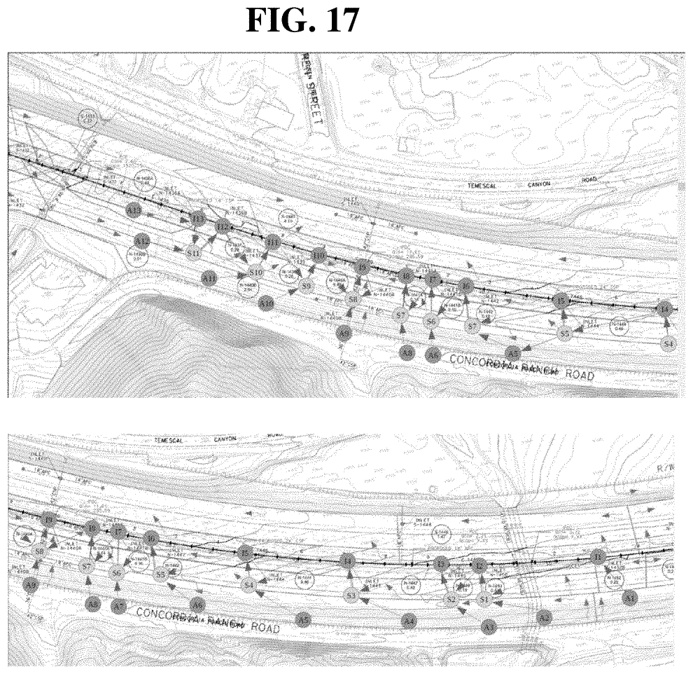

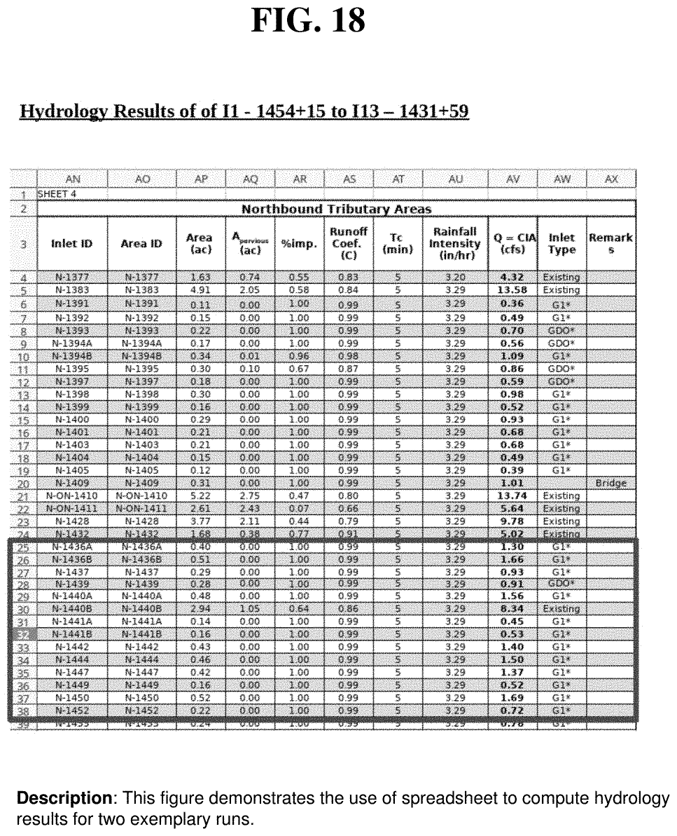

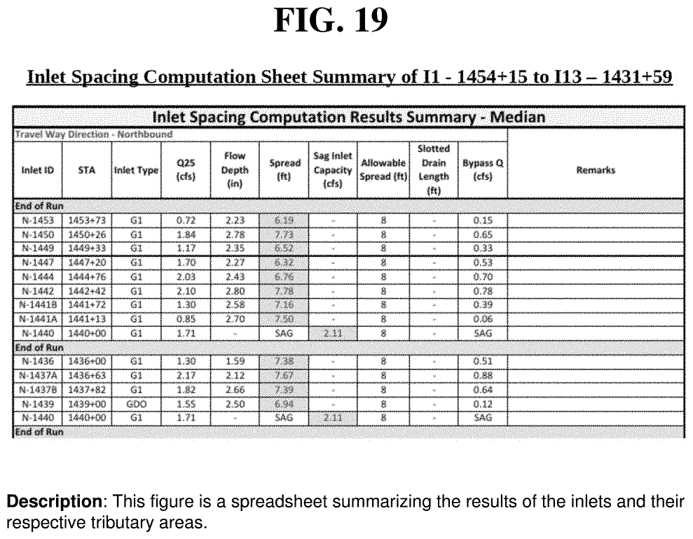

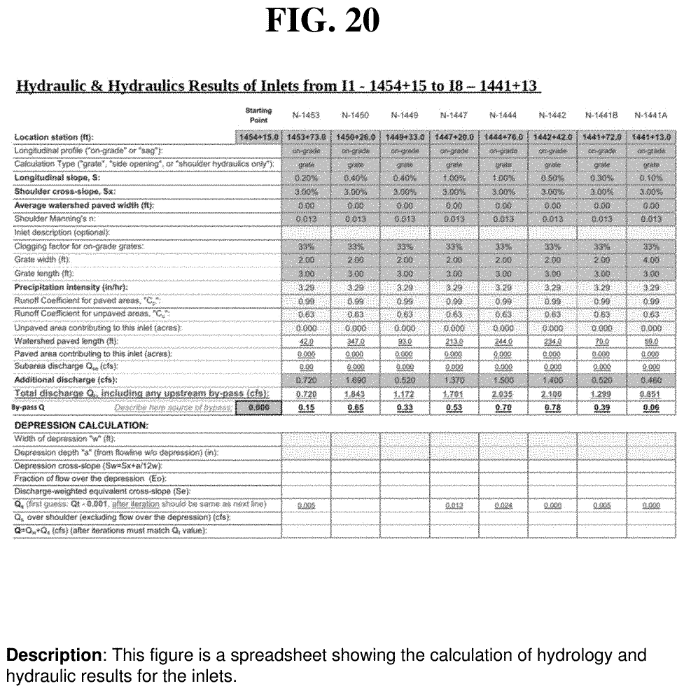

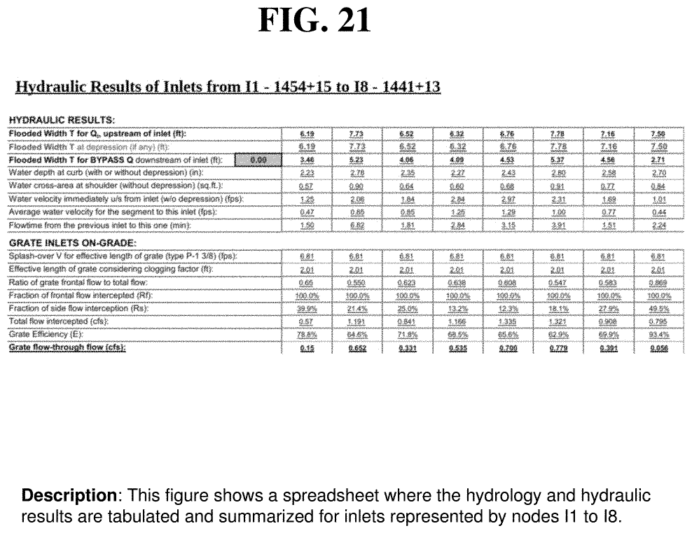

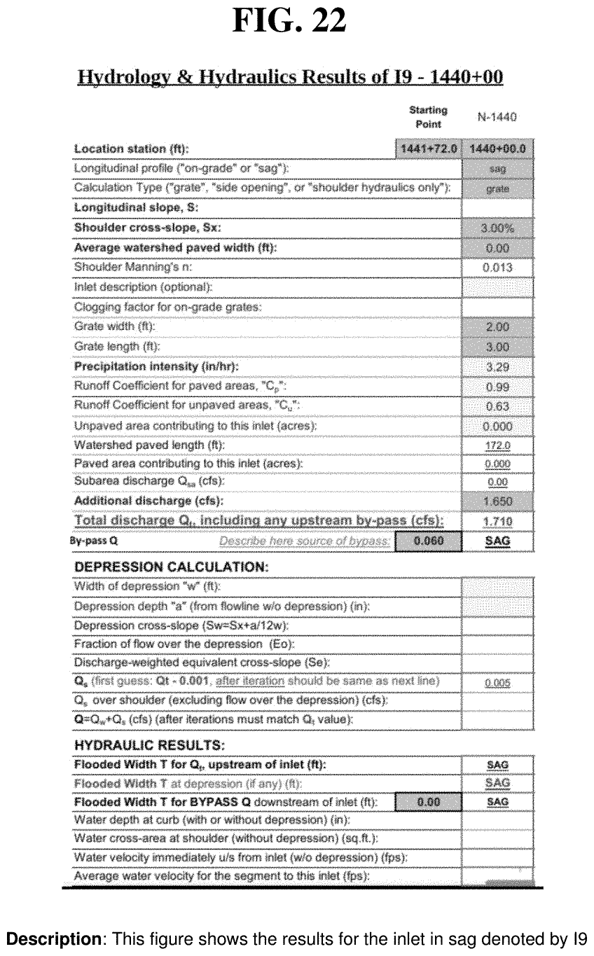

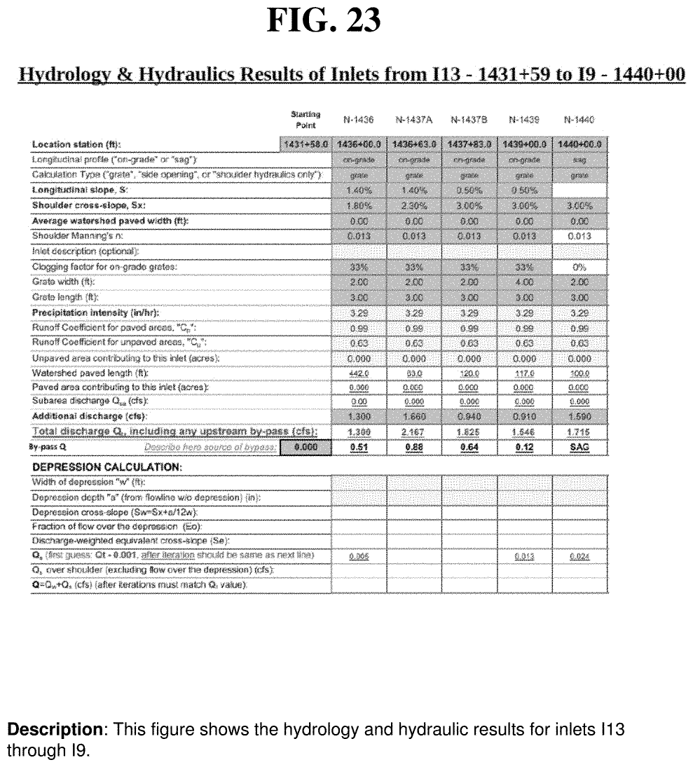

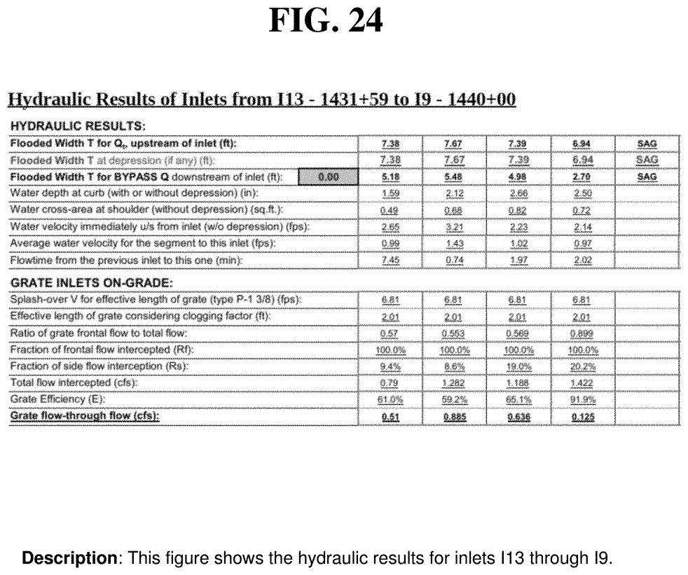

For illustrative purposes, a map is provided in FIG. 17 of an exemplary plan, wherein FIGS. 18-27 illustrate tables and diagrams corresponding to various exemplary analyses of the elements illustrated in FIG. 17 in accordance with an aspect of the subject specification.

With respect to FIG. 17, the two images show the locations of exemplary nodes. Here, the blue nodes represent the hydrology or tributary area models, whereas the red nodes represent the inlet models or the hydraulic models. Additionally, the green nodes represent a junction where the flows meet and accumulate. Then, the flows are routed to the next inlet which leaves some remainder flow which is routed to the next inlet. This pattern repeats all the way to a low elevation point where flows congregate and are completely mitigated by an inlet in a sag condition.

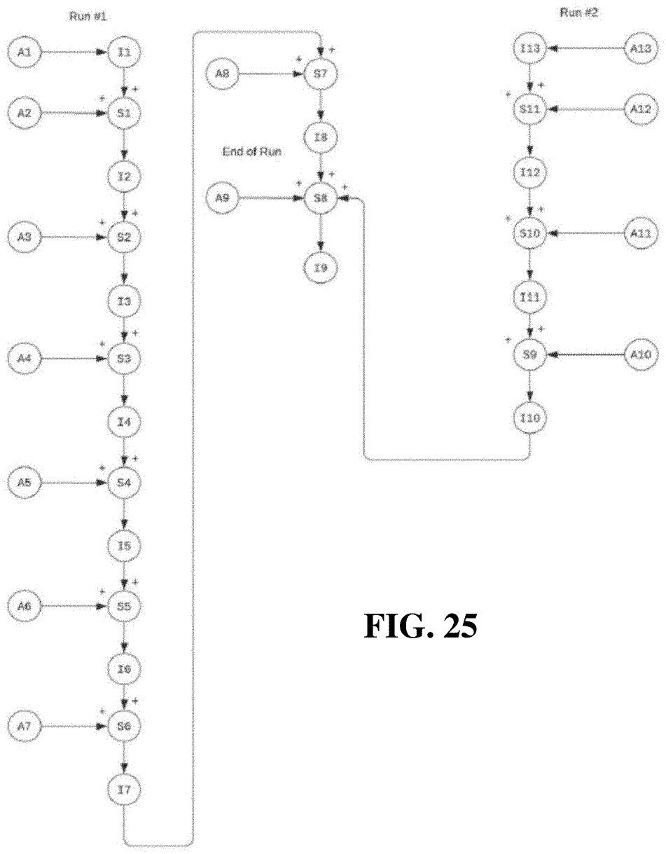

With respect to FIG. 25, this figure shows a node diagram of inlet and tributary area models which are hydraulic models and hydrology models respectively. There are two runs that meet at an end point where the inlet in sag is located which is demarcated by ‘I9’.

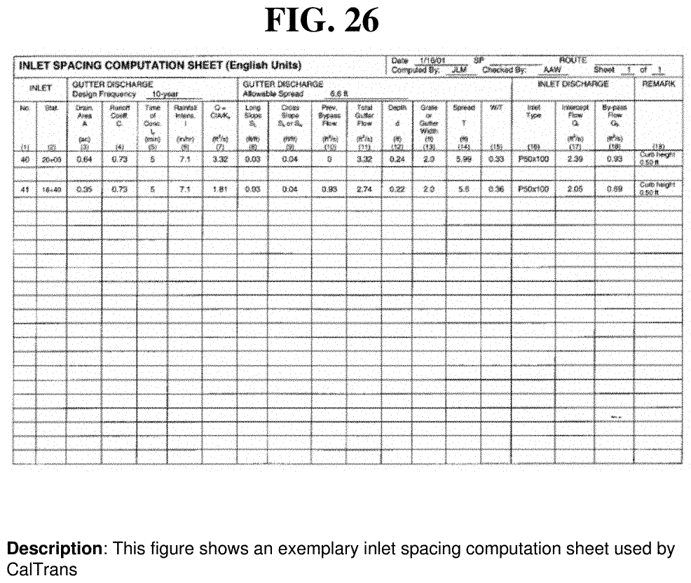

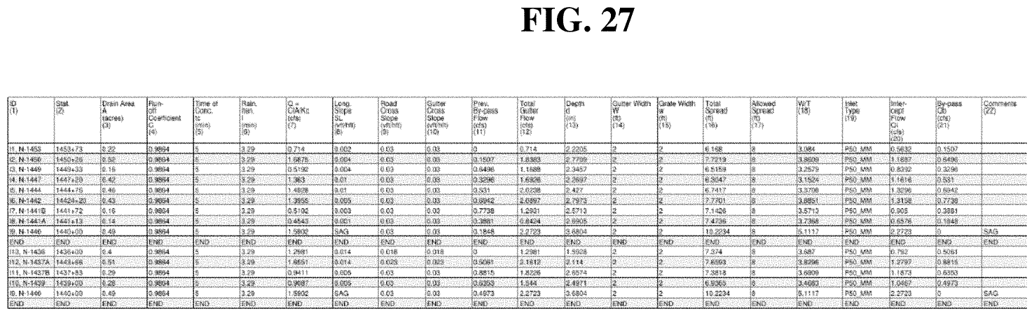

With respect to FIG. 27, this figure shows an exemplary generated result by IVE of the inlet spacing computation sheet table illustrated in FIG. 26. Notice, that the type of data present in the cells of this table are related to the inlet nodes of the node diagram illustrated in FIG. 25 and the I-15 maps illustrated in FIG. 17. The columns are defined by the inlet spacing computation sheet illustrated in FIG. 26, wherein all columns are identical except the allowable spread and comments. The allowable spread column may be set by a representative from Caltrans, for example. The first row represents the first inlet of the first identified run of the hydrology and hydraulics model shown in the maps and in the node diagram. The end of a run is denoted by the presence of an inlet in the sag condition where the flow of water is completely mitigated.

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that such embodiments can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

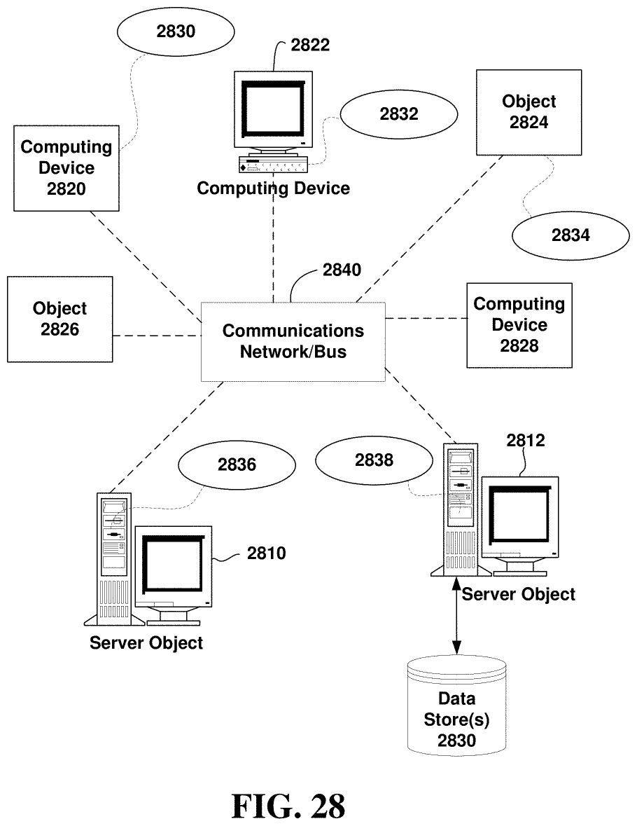

FIG. 28 provides a non-limiting schematic diagram of an exemplary networked or distributed computing environment. The distributed computing environment comprises computing objects or devices 2810, 2812, etc. and computing objects or devices 2820, 2822, 2824, 2826, 2828, etc., which may include programs, methods, data stores, programmable logic, etc., as represented by applications 2830, 2832, 2834, 2836, 2838. It can be appreciated that computing objects or devices 2810, 2812, etc. and computing objects or devices 2820, 2822, 2824, 2826, 2828, etc. may comprise different devices, such as PDAs (personal digital assistants), audio/video devices, mobile phones, MP3 players, laptops, etc.

Each computing object or device 2810, 2812, etc. and computing objects or devices 2820, 2822, 2824, 2826, 2828, etc. can communicate with one or more other computing objects or devices 2810, 2812, etc. and computing objects or devices 2820, 2822, 2824, 2826, 2828, etc. by way of the communications network 2840, either directly or indirectly. Even though illustrated as a single element in FIG. 28, network 2840 may comprise other computing objects and computing devices that provide services to the system of FIG. 28, and/or may represent multiple interconnected networks, which are not shown. Each computing object or device 2810, 2812, etc. or 2820, 2822, 2824, 2826, 2828, etc. can also contain an application, such as applications 2830, 2832, 2834, 2836, 2838, that might make use of an API (application programming interface), or other object, software, firmware and/or hardware, suitable for communication with or implementation of the disclosed aspects in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 28, as a non-limiting example, computing objects or devices 2820, 2822, 2824, 2826, 2828, etc. can be thought of as clients and computing objects or devices 2810, 2812, etc. can be thought of as servers where computing objects or devices 2810, 2812, etc. provide data services, such as receiving data from computing objects or devices 2820, 2822, 2824, 2826, 2828, etc., storing of data, processing of data, transmitting data to computing objects or devices 2820, 2822, 2824, 2826, 2828, etc., although any computer can be considered a client, a server, or both, depending on the circumstances. Any of these computing devices may be processing data, or requesting services or tasks that may implicate aspects and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 2840 is the Internet, for example, the computing objects or devices 2810, 2812, etc. can be Web servers with which the computing objects or devices 2820, 2822, 2824, 2826, 2828, etc. communicate via any of a number of known protocols, such as HTTP. As mentioned, computing objects or devices 2810, 2812, etc. may also serve as computing objects or devices 2820, 2822, 2824, 2826, 2828, etc., or vice versa, as may be characteristic of a distributed computing environment.

### Exemplary Computing Device

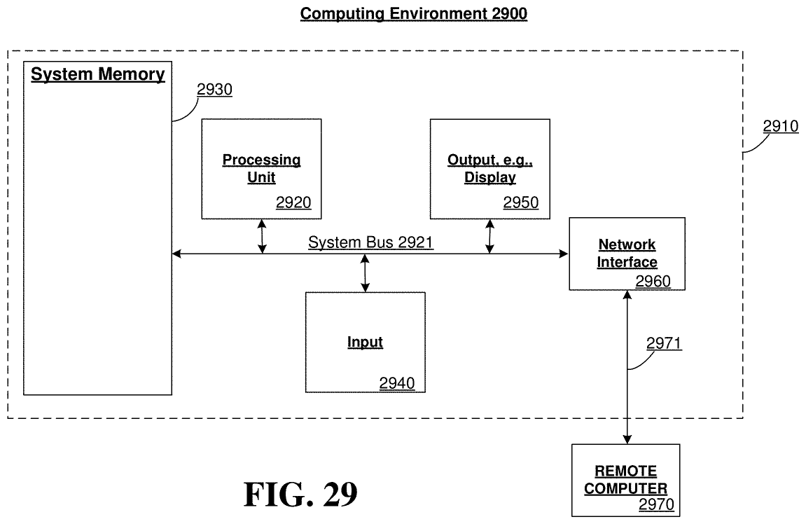

As mentioned, several of the aforementioned embodiments apply to any device wherein it may be desirable to include a computing device to facilitate implementing the aspects disclosed herein. It is understood, therefore, that handheld, portable and other computing devices and computing objects of all kinds are contemplated for use in connection with the various embodiments described herein. Accordingly, the below general-purpose remote computer described below in FIG. 29 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 29 thus illustrates an example of a suitable computing system environment 2900 in which one or more of the embodiments may be implemented, although as made clear above, the computing system environment 2900 is only one example of a suitable computing environment and is not intended to suggest any limitation as to the scope of use or functionality of any of the embodiments. The computing environment 2900 is not to be interpreted as having any dependency or requirement relating to any one or combination of components illustrated in the exemplary operating environment 2900.

With reference to FIG. 29, an exemplary remote device for implementing one or more embodiments herein can include a general-purpose computing device in the form of a handheld computer 2910. Components of handheld computer 2910 may include, but are not limited to, a processing unit 2920, a system memory 2930, and a system bus 2921 that couples various system components including the system memory to the processing unit 2920.

Computer 2910 typically includes a variety of computer readable media and can be any available media that can be accessed by computer 2910. The system memory 2930 may include computer storage media in the form of volatile and/or nonvolatile memory such as read only memory (ROM) and/or random-access memory (RAM). By way of example, and not limitation, memory 2930 may also include an operating system, application programs, other program modules, and program data.

A user may enter commands and information into the computer 2910 through input devices 2940 A monitor or other type of display device is also connected to the system bus 2921 via an interface, such as output interface 2950. In addition to a monitor, computers may also include other peripheral output devices such as speakers and a printer, which may be connected through output interface 2950.

The computer 2910 may operate in a networked or distributed environment using logical connections to one or more other remote computers, such as remote computer 2970. The remote computer 2970 may be a personal computer, a server, a router, a network PC, a peer device or other common network node, or any other remote media consumption or transmission device, and may include any or all of the elements described above relative to the computer 2910. The logical connections depicted in FIG. 29 include a network 2971, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and architectures, the underlying concepts may be applied to any network system and any computing device or system in which it is desirable to implement the aspects disclosed herein.

There are multiple ways of implementing one or more of the embodiments described herein, e.g., an appropriate API, tool kit, driver code, operating system, control, standalone or downloadable software object, etc. which enables applications to implement the aspects disclosed herein. Embodiments may be contemplated from the standpoint of an API (or other software object), as well as from a software or hardware object that facilitates implementing the aspects disclosed herein in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client-side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the present invention should not be limited to any single embodiment.

What is claimed is:

1. A method comprising:
receiving an input from a user, the input including hydrology input values corresponding to a desired interval-based analysis associated with at least one mathematical model; and
performing the desired interval-based analysis.

2. The method of claim 1, wherein the input includes at least one parameter associated with the desired interval-based analysis.

3. The method of claim 2, wherein the at least one parameter includes a jurisdiction associated with the desired interval-based analysis.

4. The method of claim 2, wherein the at least one parameter includes an interval of time associated with the desired interval-based analysis.

5. The method of claim 2, wherein the at least one parameter includes the at least one mathematical model.

6. The method of claim 5, further comprising providing the user with a plurality of selectable mathematical models, wherein the input includes a selection from the user of the at least one mathematical model from the plurality of selectable mathematical models.

7. The method of claim 5, further comprising providing the user with a customization tool configured to enable the user to create the at least one mathematical model.

8. The method of claim 1, wherein the performing of the desired interval-based analysis comprises performing a hydrology analysis and performing a hydraulic analysis, and wherein the performing of the hydraulic analysis includes auto-populating a plurality of hydraulic parameters with hydrology values retrieved from the hydrology analysis.

9. The method of claim 1, further comprising providing the user with a customization tool configured to enable the user to generate a custom report of the desired interval-based analysis.

10. The method of claim 9, wherein the input includes a desired jurisdiction, and wherein the performing of the desired interval-based analysis comprises generating the custom report in a format consistent with the desired jurisdiction.
